(19) United States
(12) Patent Application Publication
(10) Pub. No.: US 2007/0137501 A1
(43) Pub. Date: Jun. 21, 2007

(54) Oven rack grilling apparatus and method of use thereof

(76) Inventor: Aaron J. Manuel, Conyers, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/305,936

(22) Filed: Dec. 19, 2005

(51) Int. Cl. A47J 37/07

(52) U.S. Cl. 99/450

(57) ABSTRACT

An oven rack grilling apparatus combining an oven rack with a grilling basket, wherein the grilling basket is disposed within an aperture of a standard-sized oven rack. The rear portion of the oven rack is suitable for grilling larger portions of food, while the grilling basket may contain smaller food portions within the basket with its lid closed, or accommodate larger food portions with the lid open. The grilling basket is made of metal mesh to permit uniform exposure to radiant heat within the oven. In an alternate embodiment, a rotisserie may be placed within the aperture of the oven rack, with or without the grilling basket present. The rotisserie permits rotation of food disposed thereon.

### TECHNICAL FIELD

The present invention relates generally to oven shelf racks for grilling, broiling or baking food, and more specifically to an oven rack grilling apparatus comprising an oven shelf rack having a well portion that receives a grilling basket for containment of food therein.

### BACKGROUND OF THE INVENTION

Many consumers prefer to grill their food to accomplish an evenly cooked, browned, meat or vegetable. Unfortunately, consumers who live in condominiums or apartments are often not permitted to operate grills on their premises. Other consumers prefer to grill only occasionally and choose to avoid the cost of a grill since they already have an oven in their home. Additionally, grills are difficult to clean and require hazardous fuel, such as propane or natural gas in tanks, or charcoal.

On the other hand, ovens are readily available in every home, are easily cleaned and are safely fueled via electricity or piped natural gas. Ovens typically have shelf racks comprising a frame of rails around the periphery of the rack with a middle rail disposed approximately midway between the front and rear of the frame, and bars disposed perpendicular to the middle rail. In such fashion, large food portions, or smaller portions in a heat-proof container, can be cooked within the oven. However, smaller portions would otherwise fall through the rack if not so contained.

Further, many persons wish to have their food browned in an oven by direct exposure to the radiation therein. Unfortunately, loose vegetable pieces and small pieces of meat that require open access to heat for browning will not cook properly in a solid surface pan, and cannot be placed on the oven rack without falling through the gaps between the bars and rails of the rack.

Therefore, there persists the inability to grill small portions of food, browned by direct radiation from the heating elements of the oven.

### BRIEF SUMMARY OF THE INVENTION

Briefly described, in a preferred embodiment, the present invention overcomes the above-mentioned disadvantages and meets the recognized need for such a device by providing an oven rack grilling apparatus having standard-sized oven rack with an aperture therein suitable for receiving a grilling basket that can contain individual portions of food. As such, the present invention can be utilized for cooking food portions of any desired size or type in an oven without the need for a pan to hold the food portions. Accordingly, food is exposed to heat from radiating elements within an oven, permitting cooking and browning of the food as desired by the user.

According to its major aspects and broadly stated, the present invention in its preferred form is an oven rack grilling apparatus comprising a combination of an oven rack with a grilling basket, wherein the grilling basket is disposed within a well aperture of a standard-sized oven rack. The rear portion of the oven rack is suitable for grilling larger portions of food, while the grilling basket may contain smaller food portions within the basket with its lid closed, or accommodate larger food portions with the lid open. The grilling basket is comprised of metal mesh to permit uniform exposure to radiant heat within the oven. In an alternate embodiment, a rotisserie may be placed within the aperture of the oven rack, with or without the grilling basket present. Such a rotisserie is suited for grilling fowl, such as turkey, chicken, duck, quail and Cornish hens, or alternately large meat portions, such as roasts, rack of lamb or rumps. The rotisserie permits rotation of food disposed thereon.

More specifically, the present invention is a combination oven rack grilling apparatus comprising an oven rack and a removable grilling basket. The oven rack comprises a frame and a well aperture for holding the grilling basket, and left and right rails for supporting a rotisserie device defining the sides of the aperture. The left and right rotisserie rails comprise U-shaped supports to retain a removable rotisserie within the oven rack. A middle rail separately divides a front portion and a rear portion of the oven rack, wherein the front portion comprises the aperture for the grilling basket.

Additionally, the removable grilling basket comprises a well and a hinged lid, wherein the well comprises metal mesh material or the like. Left and right handles are disposed on left and right walls of the grilling basket. Hanger hooks are disposed at the junctures of the walls of the basket well, wherein the hanger hooks cooperatively engage the rotisserie rails, thereby supporting the removable grilling basket within the aperture of the oven rack. The lid is secured to the back wall of the basket well via hinges. A fastener is disposed on the front rail of the lid to cooperatively engage the front wall of the basket well, thereby enclosing the interior of the grilling basket. The grilling basket can be readily cleaned in a typical dishwasher subsequent to use.

To use the oven rack grilling apparatus, food, such as meat and vegetables, is placed in the removable grilling basket and the lid is secured over the well via the fastener on the lid. The removable grilling basket is subsequently disposed within the aperture of the oven rack, supported within the aperture via the hanger hooks. The combined oven rack grilling apparatus is subsequently placed on existing rails within an oven and inserted therein, over a pan to catch grease drippings. Food can then be cooked as desired over a typical oven temperature range of approximately 200 degrees Fahrenheit to approximately 500 degrees Fahrenheit.

In an alternate embodiment of the combination oven rack grilling apparatus, a rotisserie is disposed within the oven rack. Additionally, to permit coincident grilling of food that requires rotation via the rotisserie for optimum cooking, along with loose items such as vegetables, the lid of the basket may be left open, wherein the lid is disposed proximate the bars forming the rear portion of the oven rack. The rotisserie, with food thereon, may be subsequently disposed within the removable grilling basket, supported via the left and right U-shaped rotisserie supports, wherein the rotisserie permits rotation of the food to allow even cooking and/or browning of the food.

Accordingly, a feature and advantage of the present invention is its ability to support small portions of food within an oven while permitting access to radiation from cooking elements within the oven.

Another feature and advantage of the present invention is its ability to accommodate a rotisserie within the oven rack.

Still another feature and advantage of the present invention is its ability to keep small portions of food enclosed so that they do not fall from the oven rack onto the oven surfaces.

Yet another feature and advantage of the present invention is that it can replace a standard oven rack for home or industrial ovens.

Yet still another feature and advantage of the present invention is ability to permit grilling of food with home and/or industrial ovens.

A further feature and advantage of the present invention is its ability to accommodate and coincidentally cook large portions of food and smaller portions of food.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of an oven shelf rack according to a preferred embodiment of the present invention;

FIG. 2A is a perspective view of an open grilling basket according to a preferred embodiment of the present invention;

FIG. 2B is a perspective view of a closed grilling basket according to a preferred embodiment of the present invention;

FIG. 3 is a perspective view of a combined oven shelf rack and grilling basket according to a preferred embodiment of the present invention, shown in closed position in an oven;

FIG. 4 is a perspective view of a combined oven shelf rack and grilling basket according to a preferred embodiment of the present invention, shown in open position in an oven;

FIG. 5A is a perspective view of an oven shelf rack according to an alternate embodiment of the present invention; and,

FIG. 5B is a detail view of a rotisserie component of an oven shelf rack according to an alternate embodiment of the present invention.

### DETAILED DESCRIPTION OF THE PREFERRED AND SELECTED ALTERNATIVE EMBODIMENTS

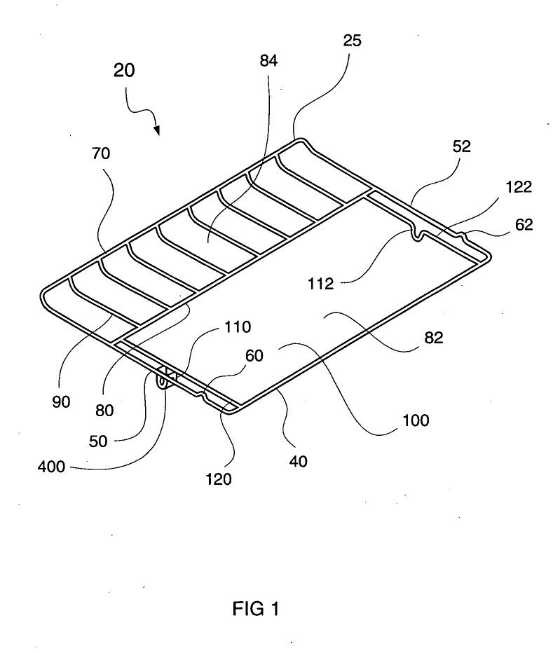

In describing the preferred and selected alternate embodiments of the present invention, as illustrated in FIGS. 1-5B, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention in a preferred embodiment is a combination oven rack grilling apparatus 10 preferably comprising oven rack 20 and removable grilling basket 30. Turning now more specifically to FIG. 1, oven rack 20 is preferably of a size suitable for typically available ovens and preferably comprises frame 25 and aperture 100, wherein frame 25 preferably comprises front rail 40, left side rail 50, right side rail 52, back rail 70, middle rail 80, left rotisserie rail 120, right rotisserie rail 122 and bars 90, wherein middle rail 80, rear portions of side rails 50, 52 and back rail 70 form a box shape, and wherein bars 90 are approximately evenly spaced and extend perpendicularly from middle rail 80 to perpendicularly join back rail 70. Front rail 40, front portions of side rails 50, 52 and middle rail 80 preferably form a box shape. Rotisserie rails 120, 122 are disposed inboard of side rails 50, 52 and parallel thereto, extending perpendicularly from front rail 40 to connect perpendicularly to middle rail 80. Middle rail 80 along with front rail 40 and side rails 50, 52 preferably separately defines front portion 82, and middle rail 80, along with back rail 70 and side rails 50, 52 preferably separately defines rear portion 84 of oven rack 20, wherein well aperture 100 substantially encompasses front portion 82 of oven rack 20. Left side rail 50 preferably comprises left ridge 60 and right side rail 52 preferably comprises right ridge 62, wherein left ridge 60 and right ridge 62 preferably engage protrusions P on rails R within oven O for positioning of oven racks 20 therein.

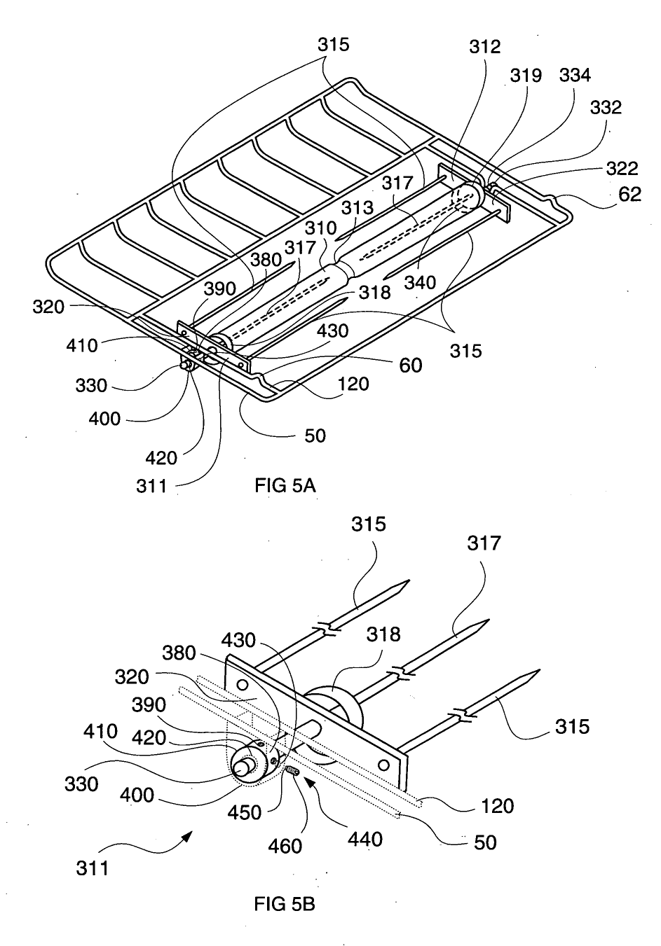

Right rotisserie rail 122 preferably comprises right rotisserie U-shaped support 112, wherein right rotisserie U-shaped support 112 receives rotisserie 300 therewithin (best shown in FIG. 5A). Support block 400 is fixedly secured to, and disposed under, left side rail 50 and left rotisserie rail 120, wherein support block 400 generally comprises a ‘U’-shape.

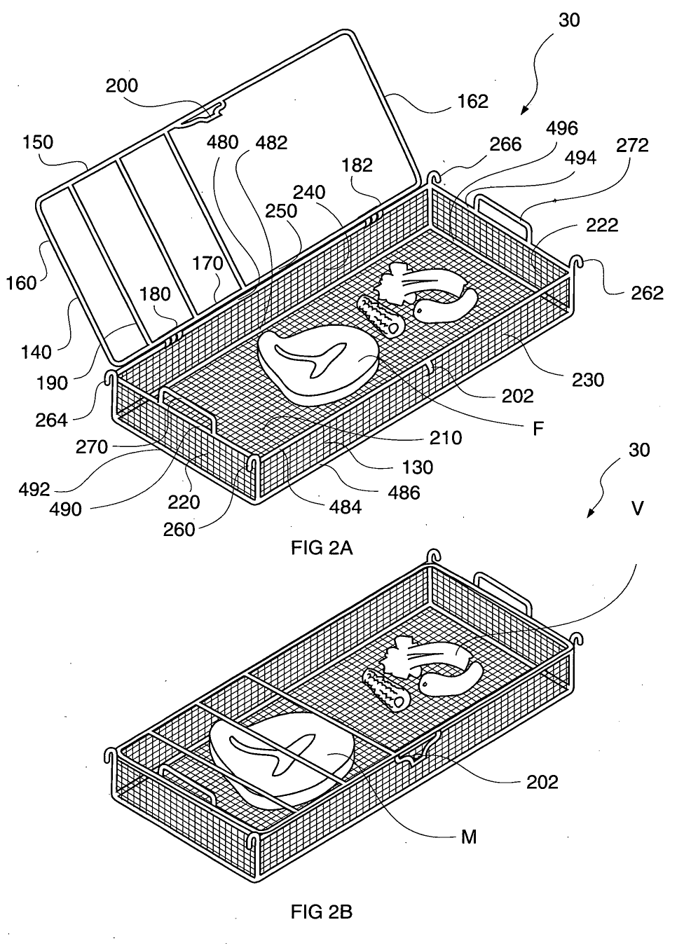

Referring more specifically to FIGS. 2A and 2B, removable grilling basket 30 preferably comprises well 130 and lid 140, wherein well 130 and lid 140 are hingedly-secured together via left hinge 180, right hinge 182.

Well 130 preferably comprises bottom 210, left wall 220, front wall 230, right wall 222 and rear wall 240, all preferably formed of metal mesh material or the like. Well 130 preferably comprises bars 480, 482, 484, 486, 490, 492, 494 and 496, wherein front bars 484, 486 and hanger hooks 260, 262 preferably define front wall 230, and wherein rear bars 480, 482 and hanger hooks 264, 266 preferably define rear wall 240. Additionally, left side bars 490, 492 and hanger hooks 260, 264 preferably define left wall 220, and right side bars 494, 496 and hanger hooks 262, 266 preferably define right side wall 222. Bottom 210 is preferably defined by front bar 486, side bars 492, 496, and rear bar 482.

Front wall 230 is preferably joined to left wall 220 via hanger hook 260 and to right wall 222 via hanger hook 262. Rear wall 240 is preferably joined to left wall 220 via hanger hook 264 and to right wall 222 via hanger hook 266. Left wall 220 and right wall 222 preferably respectively comprise left handle 270 and right handle 272. Handles 270, 272 could be either be rigidly-attached or hingedly-attached to side rods 490, 494.

Lid 140 preferably comprises front rail 150, left side rail 160, right side rail 162, back rail 170 and bars 190, wherein back rail 170 is preferably hingedly-secured to back wall 240 of well 130 via hinges 180, 182 that are connected to back rail 170. Fastener 200 is preferably disposed on front rail 150, wherein fastener 200 preferably cooperatively engages pin 202 disposed on front wall 230 of well 130, thereby forming removable grilling basket 30 into an enclosure.

To assemble, oven rack grilling apparatus 10, grilling basket 30 is inserted into aperture 100 of oven rack 20, wherein hanger hooks 260, 262, 264 and 266 preferably cooperatively engage rotisserie rails 120, 122, thereby supporting removable grilling basket 30 within aperture 100 of oven rack 20.

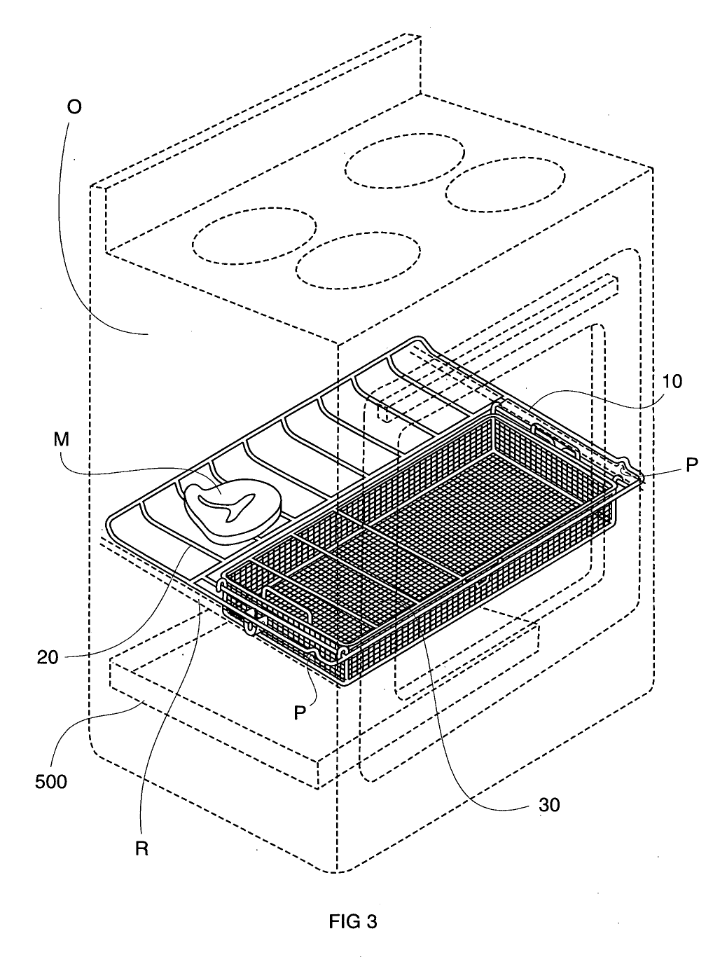

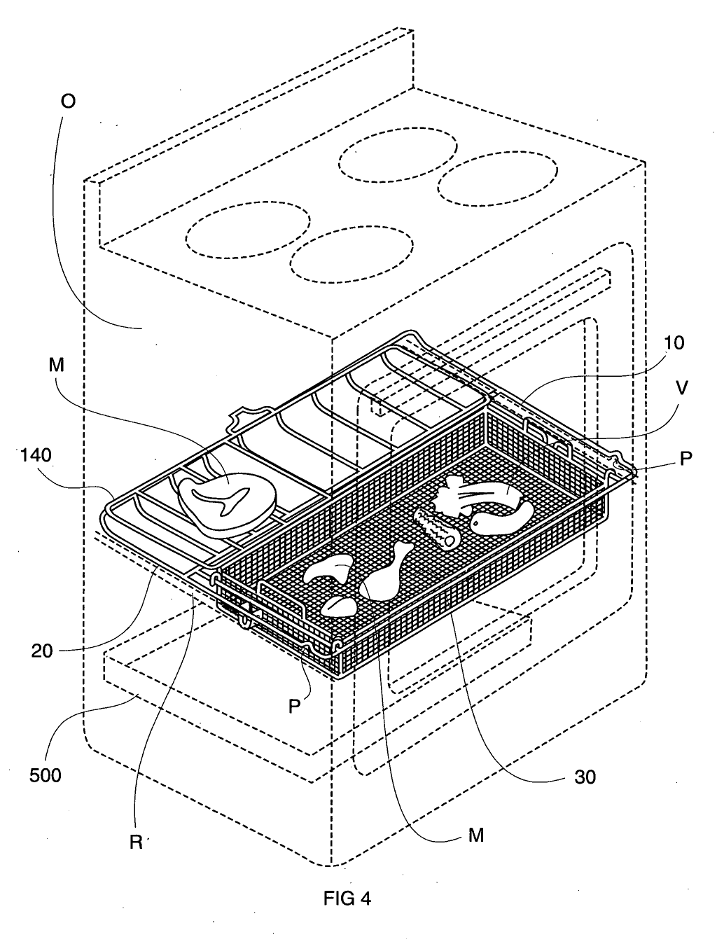

In use, food F, such as, for exemplary purposes only, meat M and vegetables V is preferably placed in removable grilling basket 30 and lid 140 is preferably closed over well 130 via fastener 200. Removable grilling basket 30 is preferably subsequently disposed within aperture 100 of oven rack 20, wherein removable grilling basket 30 is preferably supported within aperture 100 via hooks 260, 262, 264 and 266. Combined oven rack grilling apparatus 10 is preferably subsequently placed on rails R within oven O (best shown in FIGS. 3 and 4) and positioned therewithin over drip pan 500, thereby permitting cooking of food F, wherein drip pan 500 contains grease drippings.

Referring now more specifically to FIGS. 5A and B, illustrated therein is an alternate embodiment of combination oven rack grilling apparatus 10, wherein the alternate embodiment of FIGS. 5A and B is substantially equivalent in form and function to that of the preferred embodiment detailed and illustrated in FIGS. 1-4 except as hereinafter specifically referenced. Specifically, the embodiment of FIGS. 5A and B comprises combination oven rack grilling apparatus 10, wherein combination oven rack grilling apparatus 10 further comprises rotisserie 300 disposed within oven rack 20. Rotisserie 300 is preferably unpowered; however, rotisserie 300 could alternately be powered via a motor and power source.

Rotisserie 300 comprises tube 310, first end 311, and second end 312, wherein first end 311 comprises central stake 317, side stakes 315, plate 320, cup 318 and shaft 330, wherein stakes 315, 317 are fixedly secured to plate 320. Shaft 330 carries ring 380, wherein ring 380 comprises detents 390, and wherein ring 380 is fixedly secured to shaft 330. Second end 312 comprises central stake 317, side stakes 315, plate 322, cup 319 and shaft 332, wherein stakes 315, 317 are fixedly secured to plate 322. Shaft 332 comprises groove 334, wherein groove 334 is adapted to slidably rotate within ‘U’-shaped opening 112.

First end 311 and second end 312 can be disassembled from tube 310, wherein first end 311, second end 312 and tube 310 can be easily placed within a dishwasher for cleaning. First end 311 and second end 312 can selectively be utilized with or without tube 310, wherein tube 310 is suitable for engaging large openings in fowl. When utilizing first end 311 and second end 312 with tube 310, crimp 313 serves to provide retention of central stakes 317 within tube 310.

Ring 380 comprises detents 390, wherein ring 380 engages support block 400. Support block 400 comprises throughhole 420, wherein throughhole 420 is adapted to receive first end 330. Support block 400 further comprises aperture 410 and threaded throughhole 430, wherein aperture 410 is adapted to receive ring 380.

Threaded throughhole 430 is adapted to receive locking mechanism 440, wherein locking mechanism 440 cooperatively engages threaded throughhole 430, thereby securing locking mechanism 440 within support block 400. Locking mechanism 440 comprises ball end 450 and threaded body 460, wherein ball end 450 is spring loaded, and wherein, once locking mechanism 440 and rotisserie 300 are engaged within support block 400, ball end 450 removably engages detents 390 of ring 380 to permit selective rotation of rotisserie 300 by incremental turns, such as, for exemplary purposes only, quarter turns.

When placing rotisserie 300 in position for use, food F is placed on side stakes 315 and/or central stakes 317, or alternately, tube 310 can be inserted through food F with subsequent insertion of central stakes 317 into tube 310. Tube 310 is hollow and is selectively removably disposed over central stakes 317 of ends 311, 312 of rotisserie 300.

First end 311 is removably disposed through and within block 400, and second end 312 is disposed within U-shaped opening 342, wherein groove 334 is carried by U-shaped opening 342. Once in position, rotisserie 300 can be rotated as required to cause food F to brown evenly.

Additionally, to permit coincident grilling of food F that requires rotation for optimum cooking, along with loose items such as vegetables V, lid 140 may be left open when removable grilling basket 30 is disposed within well 130, wherein lid 140 is disposed proximate rear portion 84 of oven rack 20. Rotisserie 300, with food F thereon, may be subsequently disposed over grilling basket 30 within support block 400 and right rotisserie U-shaped support 112.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An oven rack grilling apparatus comprising:
an oven rack having a well aperture therein, wherein said well aperture substantially encompasses a front section of said oven rack.

2. The oven rack grilling apparatus of claim 1, further comprising a grilling basket, wherein said grilling basket is disposed within said oven rack.

3. The oven rack grilling apparatus of claim 2, wherein said oven rack is adapted to receive said grilling basket within said well aperture.

4. The oven rack grilling apparatus of claim 2, wherein said oven rack comprises rails and bars defining a rear portion of said grilling basket, and wherein a lid of said grilling basket is dimensioned to approximately match said rails and bars of said oven rack.

5. The oven rack grilling apparatus of claim 4, wherein said lid comprises a means for fastening said lid to a well portion of said grilling basket.

6. The oven rack grilling apparatus of claim 4, wherein said lid is hingedly-secured to a well portion of said grilling basket.

7. The oven rack grilling apparatus of claim 2, wherein said grilling basket comprises a well formed of metal mesh material.

8. The oven rack grilling apparatus of claim 1, wherein said oven rack comprises U-shaped supports.

9. The oven rack grilling apparatus of claim 8, wherein said U-shaped supports are adapted to receive a rotisserie.

10. The oven rack grilling apparatus of claim 9, further comprising a rotisserie.

11. The oven rack grilling apparatus of claim 1, wherein said grilling basket comprises handles.

12. The oven rack grilling apparatus of claim 2, wherein said grilling basket comprises hook supports adapted to engage said oven rack.

13. A method of cooking, said method comprising the steps of:
inserting an oven rack into an oven, wherein said oven rack comprises an aperture defined to receive a grilling basket therein; and
cooking food utilizing said oven rack.

14. The method of claim 13, further comprising the steps of:
placing food in said grilling basket; and
inserting said grilling basket into said aperture defined in said oven rack.

15. The method of claim 14, further comprising the step of:
supporting said grilling basket via hook supports.

16. The method of claim 13, further comprising the step of:
enclosing the food within said grilling basket via a lid.

17. The method of claim 13, further comprising the step of:
placing a drip pan within said oven.

18. The method of claim 14, further comprising the step of:
supporting a rotisserie within said aperture defined in said oven rack.

19. The method of claim 14, further comprising the step of:
placing food on a lid portion of said grilling basket, wherein said lid portion is disposed proximate a rear portion of said oven rack;
placing food in said grilling basket; and
cooking the food on said lid and in a well portion of said grilling basket.

20. An oven rack grilling apparatus comprising:
an oven rack having an aperture therein; and
means for grilling food disposed within said aperture.
